(19) United States
(12) Patent Application Publication
(10) Pub. No.: US 2020/0165104 A1
(43) Pub. Date: May 28, 2020

(54) ELEVATOR CAR APRON

(71) Applicant: Otis Elevator Company, Farmington, CT (US)

(72) Inventors: Joachim Angoulevant, Saint Martin d'Abbat (FR); Etienne Billant, Coullons (FR)

(21) Appl. No.: 16/680,731

(22) Filed: Nov. 12, 2019

(30) Foreign Application Priority Data
Nov. 22, 2018 (EP) 18306554.9

(51) Int. Cl. B66B 13/28; B66B 11/02; B66B 1/06

(52) U.S. Cl. CPC B66B 13/285; B66B 1/06; B66B 11/0226

(57) ABSTRACT

Elevator systems are provided. The systems include an elevator car movable along an elevator shaft, the shaft having a pit floor, the elevator car having an elevator car door sill and a car apron assembly. The car apron assembly includes an apron frame movably mounted to the elevator car, the apron frame having a frame base, a winding mechanism mounted within the elevator car door sill, and a semi-rigid curtain attached to the winding mechanism and extending to the frame base. The semi-rigid curtain is configured to transition between a deployed state and a stowed state, wherein when in the deployed state the semi-rigid curtain extends below the elevator car to block an open landing door that is lower than the elevator car when the elevator car is positioned offset and above an adjacent landing, and when in the stowed state the semi-rigid curtain is wound about the winding mechanism.

### BACKGROUND

The subject matter disclosed herein generally relates to elevator systems and, more particularly, to elevator car aprons and safety mechanisms for elevator systems.

Traditional safety requirements for elevator shafts have led to larger spaces both at the top and bottom of the elevator shaft. However, such enlarged spaces may be disadvantageous for architectural reasons. Thus, elevator manufacturers have attempted to reduce hoistway or elevator shaft overhead dimensions and pit depth while maintaining safety features. Mechanics currently go to the top of car, or on top thereof, or in the pit, for inspection or maintenance activity of various components of an elevator car system. Thus, safety spaces or volumes are employed within the elevator shaft to protect a mechanic in the event of an emergency and thus require increased overhead and pit dimensions.

Further advancements and designs have attempted to completely eliminate the need for a mechanic to enter the hoistway, thus improving safety. An advantage of eliminating the need for entering the hoistway is that the traditional large pit depths may be reduced such that very small pit depths may be employed in such elevator systems.

Elevator cars typically include a toe guard or car apron situated beneath the elevator car door. The car apron is arranged to prevent persons from falling into an elevator shaft if the elevator car is not located at a landing and the landing doors are opened. The car apron is typically rigid and has a nominal height of about 750 mm. A significant amount of clearance beneath the elevator car is required to avoid contact between the car apron and the bottom of the elevator shaft when the elevator car is situated at a lowest landing. Such contact could cause significant damage to the car apron due to the rigid and fixed nature of the car apron. Accordingly, retractable car aprons have been proposed to address the above issues for systems employing small pit depths. However, improved systems may be advantageous.

### BRIEF SUMMARY

According to some embodiments, elevator systems are provided. The elevator systems include an elevator car movable along an elevator shaft, the shaft having a pit floor, the elevator car having an elevator car door sill and a car apron assembly. The car apron assembly includes an apron frame movably mounted to the elevator car, the apron frame having a frame base, a winding mechanism mounted within the elevator car door sill, and a semi-rigid curtain attached to the winding mechanism and extending to the frame base. The semi-rigid curtain is configured to transition between a deployed state and a stowed state, wherein when in the deployed state the semi-rigid curtain extends below the elevator car to block an open landing door that is lower than the elevator car when the elevator car is positioned offset and above an adjacent landing, and when in the stowed state the semi-rigid curtain is wound about the winding mechanism.

In addition to one or more of the features described above, or as an alternative, further embodiments may include that the semi-rigid curtain is formed from at least one of rubber, plastic, fabric, metallic chain links, plastic chain links, metal mesh, and plastic mesh.

In addition to one or more of the features described above, or as an alternative, further embodiments may include that the apron frame includes a guide arranged to provide support to the semi-rigid curtain and to guide movement of the semi-rigid curtain between the deployed state and the stowed state.

In addition to one or more of the features described above, or as an alternative, further embodiments may include an apron stop on an end of the guide opposite the frame base and a shaft stop arranged within the elevator shaft at a stop height from the pit floor, the shaft stop positioned within the elevator shaft to interact with the apron stop. The apron stop is configured to contact the shaft stop and cause the semi-rigid curtain to transition from the deployed state to the stowed state.

In addition to one or more of the features described above, or as an alternative, further embodiments may include a driving cable operably connecting the winding mechanism to the guide.

In addition to one or more of the features described above, or as an alternative, further embodiments may include a pulley, wherein the driving cable wraps about the pulley.

In addition to one or more of the features described above, or as an alternative, further embodiments may include a housing positioned within the elevator car door sill, wherein the winding mechanism is attached to the housing.

In addition to one or more of the features described above, or as an alternative, further embodiments may include that the winding mechanism includes a shaft rotatably mounted to the elevator car door sill and a drum driven by rotation of the shaft, wherein the semi-rigid curtain is configured to be wound about the drum.

In addition to one or more of the features described above, or as an alternative, further embodiments may include a self-lubricated bushing arranged between the shaft and the drum.

In addition to one or more of the features described above, or as an alternative, further embodiments may include a contact surface on an exterior of the drum and configured to prevent the semi-rigid curtain from sticking to the drum.

In addition to one or more of the features described above, or as an alternative, further embodiments may include that the semi-rigid curtain is attached to the drum by one or more fasteners.

In addition to one or more of the features described above, or as an alternative, further embodiments may include an apron guide arranged within the elevator car door sill, the apron guide configured to guide movement of the semi-rigid curtain between the deployed state and the stowed state.

In addition to one or more of the features described above, or as an alternative, further embodiments may include that the apron frame includes an apron buffer, the apron buffer configured to contact the pit floor to urge the semi-rigid curtain from the deployed state to the stowed state.

In addition to one or more of the features described above, or as an alternative, further embodiments may include a biasing element operably connecting the apron frame to a car frame of the elevator car.

In addition to one or more of the features described above, or as an alternative, further embodiments may include that the elevator car includes a second apron assembly.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 is a schematic illustration of an elevator system that may employ various embodiments of the present disclosure;

FIG. 2 is a schematic illustration of an elevator system that may employ various embodiments of the present disclosure illustrating a car apron assembly;

FIG. 3 is a schematic illustration of an elevator system having a car apron assembly in accordance with an embodiment of the present disclosure with the car apron assembly in a deployed state;

FIG. 4A is a schematic isometric view of a car apron assembly in accordance with an embodiment of the present disclosure;

FIG. 4B is a side elevation view of the car apron assembly of FIG. 4A shown in a deployed state;

FIG. 4C is a side elevation view of the car apron assembly of FIG. 4A shown in a stowed state;

FIG. 5 is a schematic illustration of an elevator car having two car apron assemblies in accordance with an embodiment of the present disclosure;

FIG. 6 is a schematic illustration of a portion of a car apron assembly in accordance with an embodiment of the present disclosure;

FIG. 7A is an isometric illustration of a car apron assembly in accordance with an embodiment of the present disclosure, in a deployed state;

FIG. 7B is an isometric illustration of the car apron assembly of FIG. 7A shown in a stowed state; and

FIG. 7C is an enlarged illustration of a portion of the car apron assembly of FIG. 7A.

### DETAILED DESCRIPTION

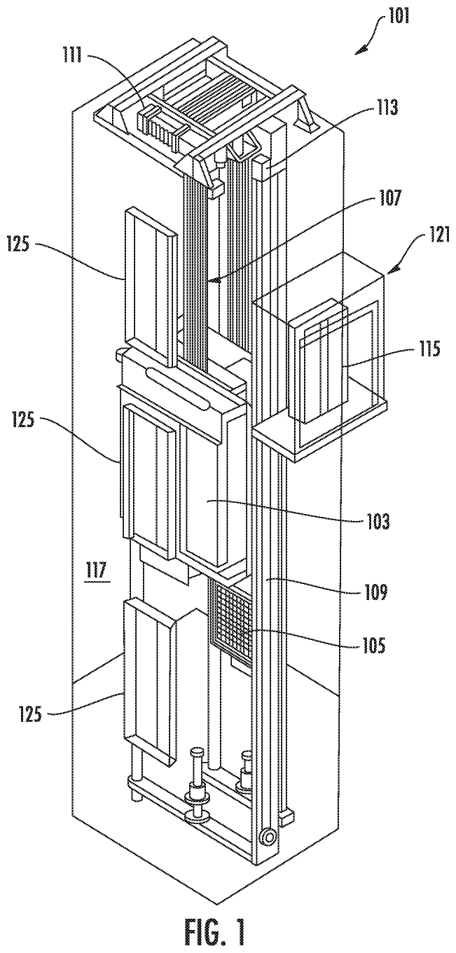

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to the tension member 107 to move the elevator car 103 within the elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

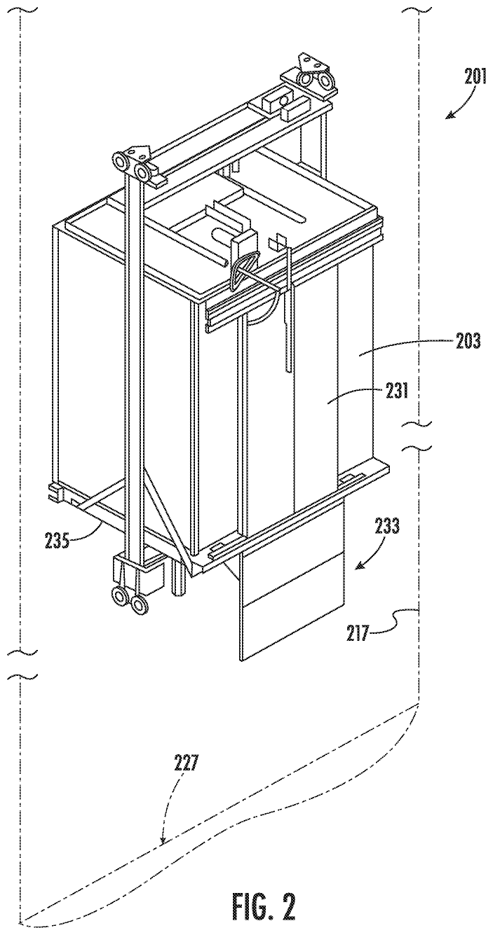

FIG. 2 is a schematic illustration of an elevator system 201 that can incorporate embodiments of the present disclosure. The elevator system 201 includes an elevator car 203 that is moveable within an elevator shaft 217. A pit floor 227 is shown at the bottom of the elevator shaft 217. The elevator car 203 includes elevator car doors 231 that open and close to allow ingress/egress to/from the elevator car 203 at one or more landings of the elevator system 201.

A car apron assembly 233 is provided on the elevator car 203 to cover the space between a bottom 235 of the elevator car 203 and an adjacent landing, when the elevator car 203 is in the proximity of the landing. If, for any reason, the landing doors (not shown) were to open before the elevator car 203 is properly aligned with the landing, the car apron assembly 233 is provided to at least partially block the open landing door. One function of the car apron assembly 233 is to prevent people from falling in the elevator shaft 217 during rescue operations when the elevator car door 231 is not aligned with a landing door.

However, the presence of the car apron assembly 233 impacts how close the elevator car 203 can get to the pit floor 227 of the elevator shaft 217. The example car apron assembly 233 of the present embodiment is collapsible or movable between an extended state (shown in FIG. 2) and a retracted state (not shown) that allows the elevator car 203 to descend closer to the pit floor 227 than may otherwise be possible to if the car apron assembly 233 remained in the extended state. That is, the dimensions of the car apron assembly 233 in the retracted state are significantly less than the dimensions of the car apron assembly 233 in an extended state.

In accordance with some embodiments of the present disclosure, car apron assemblies that provide landing doorway coverage and enable the use of small or low clearance pit depths in elevator systems are described. In some embodiments, the coverage provided by the car apron assemblies described herein may provide full or less-than-full coverage (e.g., ¾, ½, etc.) of an elevator landing doorway opening. In accordance with embodiments of the present disclosure, car apron assemblies are arranged to close the gap between an elevator car door sill and a landing door sill using a semi-rigid, flexible curtain having a length that can extend to a value equal to the landing door opening height. The semi-rigid curtain is fixed at its upper part below the elevator car door sill and is maintained vertical during operation of the elevator car due to a support frame that is mounted to the elevator car. The semi-rigid curtain is arranged to provide a horizontal resistance (e.g., 300 N, 35 mm deflection, and 1 mm permanent deflection) in the event of a hazard (e.g., a person contacting the semi-rigid curtain). The semi-rigid curtain provides a constant and always deployed extension to block access to the elevator shaft below the elevator car. However, when the elevator car reaches the lowest landing, the semi-rigid curtain may be rolled or wound to prevent contact with the pit floor or minimize an impact if contact with the pit floor occurs.

In accordance with embodiments of the present disclosure, a winding mechanism is provided to roll or wind a semi-rigid curtain when an elevator car approaches a pit of an elevator shaft.

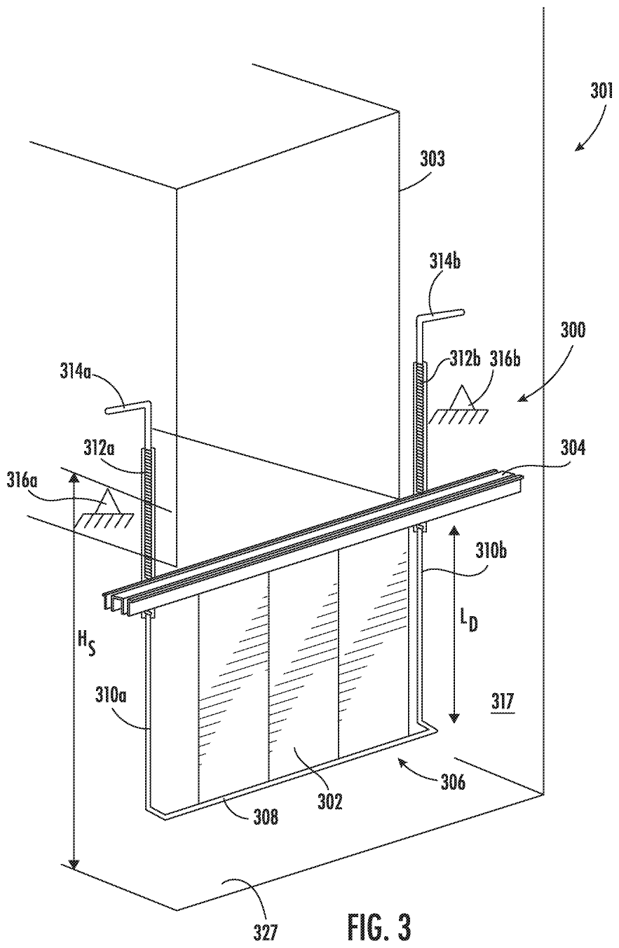

For example, turning to FIG. 3, a schematic illustration of an elevator system 301 having a car apron assembly 300 in accordance with an embodiment of the present disclosure is shown. The elevator system 301 includes an elevator car 303 that is movable within an elevator shaft 317 between a number of different landings along the elevator shaft 317. The elevator shaft 317 extends between a pit floor 327 and an elevator shaft top. Although not shown, the elevator car 303 is moveable along one or more guide rails and may be suspended from a roping system, as described above and as appreciated by those of skill in the art. At each landing, a landing door may provide openable access to the elevator car 303, when the elevator car 303 is located at the respective landing, and/or may provide access to the elevator shaft 317 if the elevator car 303 is not present. As such, the car apron assembly 300 is provided to prevent injury if the landing doors are open and the elevator car 303 is not aligned with the given landing.

The car apron assembly 300 includes a semi-rigid curtain 302 that is attached to and suspended from the elevator car 303. As will be appreciated by those of skill in the art, the semi-rigid curtain 302 may be attached at an elevator car door sill 304. In some embodiments, the semi-rigid curtain 302 is installed within and extends from the elevator car door sill 304 (e.g., within the sill or a housing connected thereto). The semi-rigid curtain 302 extends downward from and below the elevator car 303, as shown in FIG. 3. In the embodiment shown in FIG. 3, the semi-rigid curtain 302 extends from the elevator car door sill 304 a deployed length L_{D} and is supported by an apron frame 306. The apron frame 306 provides rigidity, support, and weight to the semi-rigid curtain 302. The apron frame 306, in some embodiments, may be a metal rod frame that extends a width of the semi-rigid curtain 302 to provide a weight at the bottom of the semi-rigid curtain 302 and to ensure the semi-rigid curtain 302 remains taut and aligned with an orientation of the elevator car door sill 304 (e.g., may prevent twisting of the semi-rigid curtain 302). Further, as described below, the apron frame 306 may be slidable or moveable relative to the elevator car 303 and/or the pit floor 327.

In some embodiments, the apron frame 306 may be a weighted element to apply a downward force (e.g., by gravity) on the semi-rigid curtain 302. As shown, the lower end of the semi-rigid curtain 302 may be connected to a frame base 308 of the apron frame 306. The apron frame 306 also includes support arms 310a, 310b that extend from the frame base 308 into respective biasing assemblies 312a, 312b. The support arms 310a, 310b pass through the respective biasing assemblies 312a, 312b and, at an end opposite the frame base 308, each support arm 310a, 310b includes a respective apron stop 314a, 314b. The frame base 308, the support arms 310a, 310b, and the apron stops 314a, 314b form a rigid structure, and thus all elements thereof are moveable as a single unit or piece. Although shown with a support arm, a biasing assembly, and an apron stop on each side of the elevator car 303, such arrangement is not to be limiting. For example, in some embodiments, a single support arm may pass through a single biasing assembly installed on one side of the elevator car, and a single apron stop may be arranged on the end of the support arm. In such embodiments, as will be appreciated by those of skill in the art, the apron frame 306 may be made with sufficient rigidity to function as described herein, using a single apron stop and support arm.

The biasing assemblies 312a, 312b may be piston-style elements that can, in part, compress when the frame base 308 contacts the pit floor 327. The biasing assemblies 312a, 312b are fixedly mounted to an exterior of the elevator car 303, with the support arms 310a, 310b passing therethrough. Although a specific biasing assembly arrangement is shown, such embodiment is merely provided for illustrative and explanatory purposes. Other biasing arrangements may be employed without departing from the scope of the present disclosure. For example, piston-style assemblies may be employed, and various biasing elements such as, but not limited to, tension springs, compression springs, gas springs, etc. may be implemented. Further, a gravity-based biasing element or assembly may be employed without departing from the scope of the present disclosure. Alternatively, and as illustratively shown and described below, a system may be set to prevent contact of the frame base 308 with the pit floor 327.

As noted, the semi-rigid curtain 302 extends a deployed length LD during normal operation of the elevator car 303, as shown in FIG. 3. The deployed length L_{D} may have any desired length to provide fall protection in the event that a landing door is opened and the elevator car is located above the opening. In some non-limiting embodiments, the deployed length L_{D} may be 750 mm or greater, and in some embodiment may be between 750-5000 mm, and in some embodiments, the deployed length L_{D} may be about 750 mm.

If the elevator car 303 travels to the pit of the elevator shaft 317, the elevator car door sill 304 may approach the pit floor 327 to a distance that is less than the deployed length LD. In such instances, it may be advantageous to prevent contact with or minimize impact by contact with the pit floor 327 and the semi-rigid curtain 302. As described herein, embodiments of the present disclosure are directed to retracting, coiling, winding, or otherwise rolling-up the semi-rigid curtain 302 to prevent damage thereto.

The retraction of the semi-rigid curtain 302 may be achieved, in some embodiments, by application of force to the apron frame 306. Proximate the pit floor 327, the elevator system 301 includes shaft stops 316a, 316b that are interactive with the apron stops 314a, 314b. The shaft stops 316a, 316b are positioned a stop height Hₛ from the pit floor 327. The shaft stops 316a, 316b may be mounted to the shaft walls of the elevator shaft 317, mounted to a guide rail of the elevator system 301, mounted to a landing door assembly/frame (e.g., lowest landing door), or elsewhere within the elevator shaft 317. The shaft stops 316a, 316b are positioned such that if the elevator car 303 travels toward the pit floor 327 at the bottom of the elevator shaft 317, the apron stops 314a, 314b will contact the respective shaft stops 316a, 316b. The shaft stops 316a, 316b will apply force to the apron stops 314a, 316b and urge the apron frame 306 toward the elevator car 303. The stop height Hₛ is set such that the apron frame 306 does not contact the pit floor 327, thus preventing damage to the apron frame 306 and/or to the semi-rigid curtain 302. When the elevator car 303 travels away from the pit floor 327, the biasing assemblies 312a, 312b will cause the apron frame 306 and the semi-rigid curtain 302 to move back to the deployed state.

In some non-limiting embodiments, the car apron assembly 300 may be arranged to meet certain predetermined criteria. For example, the deployed length L_{D} of the semi-rigid curtain 302 may be at least two meters to ensure that a landing door opening would be covered during a rescue operation. Further, the apron frame 306 and the material of the semi-rigid curtain 302 may be selected to prevent a specific deflection and/or impacts and thus prevent persons or objects from falling into the elevator shaft 317. For example, the car apron assembly 300 may be arranged to provide a horizontal resistance (e.g., from a landing into the elevator shaft 317) of between 200-700 N with between a 5-50 mm deflection. Further, in some embodiments, the resistance may be between 300-500 N with a 15-35 mm deflection. In some embodiments, the apron assembly may be configured to have a maximal permanent deflection of about 1 mm.

It is noted that in addition to providing a safety cover or protection at a landing, the car apron assembly 300 is arranged to allow for simple operation at the lowest level of the elevator shaft 317 and/or at the pit floor 327. For example, in some embodiments, the stops 314a, 314b, 316a, 316b and the biasing assemblies 312a, 312b may be eliminated, and the operation of the semi-rigid curtain 302 as described herein is initiated by contact with the pit floor 327.

To enable the retraction or stowage of the semi-rigid curtain, while maintaining appropriate or desirable resistance to force/impact, the semi-rigid curtain may be formed from a specific material that enables winding or rolling and re-deployment while providing a strength thereto. For example, in some embodiments, without limitation, the semi-rigid curtain of the present disclosure may be formed from rubber, plastic (e.g., a tarp-like material, etc.), fabric (e.g., canvas, nylon, etc.), metallic and/or plastic chain links, metal or plastic mesh, etc. In some embodiments, the material of the semi-rigid curtain may be selected to ensure a relatively quiet rolling or winding when contacting the pit floor or anchors of the system. Further, the material may be selected to minimize a total weight of the car apron assembly. Moreover, the selection of the material may be made to ensure that in a stowed or wound state the semi-rigid curtain may fold into a preset space (e.g., within a frame or housing of an elevator car door sill), and yet extend to a full length in normal operation. For example, in one non-limiting example, the semi-rigid curtain may have a deployed length of greater than 1 meter, and a collapsed or folded dimension of less than 200 mm. Further, in some non-limiting embodiments, the deployed length may be between 750 mm and 5 meters and the collapsed dimension may be less than 200 mm. Further still, in some embodiments, the deployed length may be about 750 mm and the collapsed dimension may be about 180 mm.

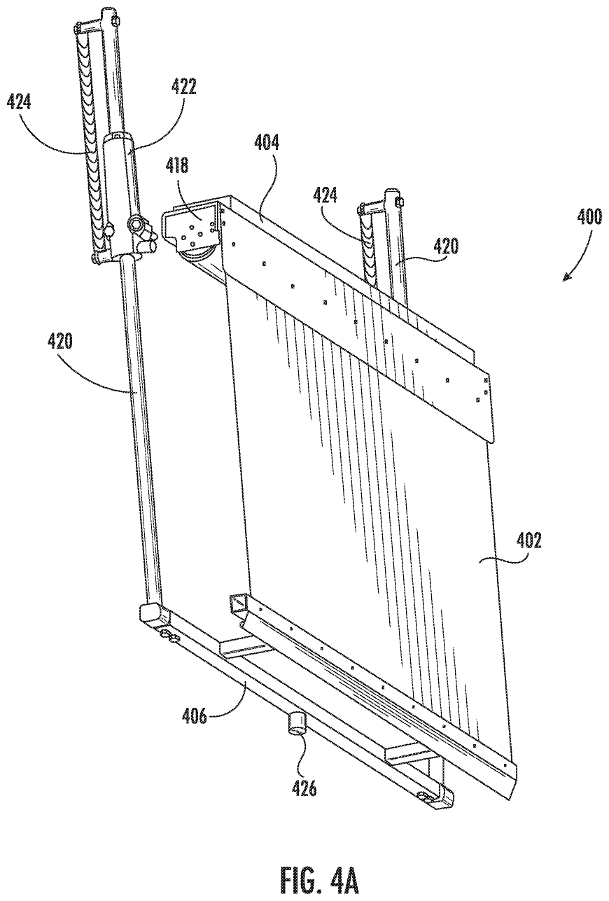

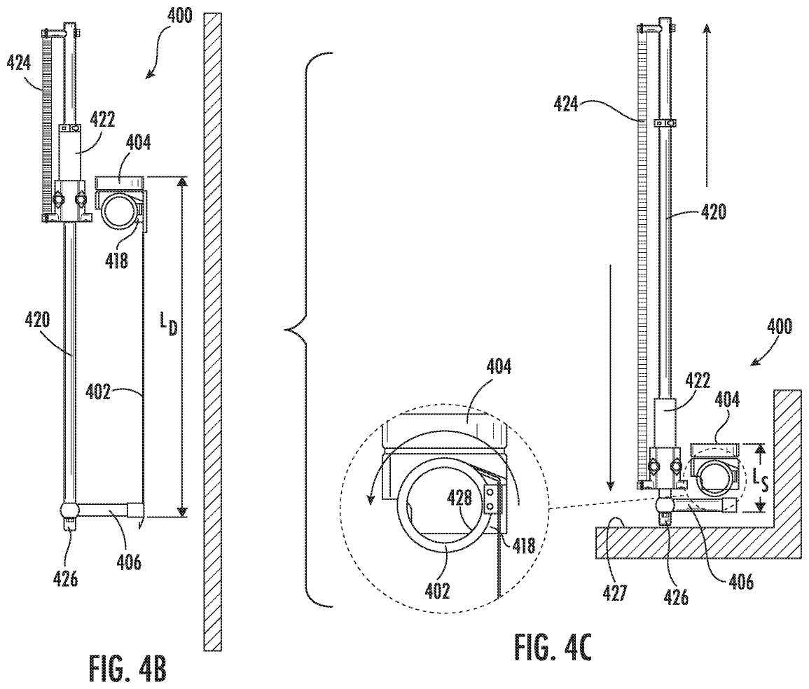

Turning now to FIGS. 4A-4C, schematic illustrations of a car apron assembly 400 in accordance with an embodiment of the present disclosure are shown. The car apron assembly 400 may be installed to an elevator car, as shown and described above. The car apron assembly 400 is provided to prevent injury if the landing doors are open and the elevator car is not aligned with a given landing. FIG. 4A illustrates an isometric view of the car apron assembly 400. FIG. 4B illustrates a side elevation view of the car apron assembly 400 in a deployed and normal operating state. FIG. 4C illustrates a side elevation view of the car apron assembly 400 in a wound or collapsed state when an elevator car is located proximate a pit floor of an elevator shaft.

The car apron assembly 400 includes a semi-rigid curtain 402 that is installed in and suspended from an elevator car door sill 404 of an elevator car. As shown, the semi-rigid curtain 402 is housed within a housing 418 that may be part of the elevator car door sill 404. The semi-rigid curtain 402 extends downward from and below the elevator car door sill 404, as shown in FIGS. 4A-4B. As shown in FIG. 4B, the semi-rigid curtain 402 extends from the elevator car door sill 404 a deployed length LD and is supported by an apron frame 406. The apron frame 406 provides rigidity, support, and weight to the semi-rigid curtain 402. The apron frame 406, in some embodiments, may be a metal rod or beam frame that extends a width of the semi-rigid curtain 402 to provide a weight at the bottom of the semi-rigid curtain 402 and to ensure the semi-rigid curtain 402 remains taut and aligned with an orientation of the elevator car door sill 404 (e.g., may prevent twisting of the semi-rigid curtain 402). Further, as described below, the apron frame 406 may be slidable or moveable relative to the elevator car and/or a pit floor, as described above.

The apron frame 406 may include one or more guides 420. The guides 420 may be similar in structure and operation as the support arms described above. The guides 420 may be operably connected to a car frame 422 (e.g., part of an elevator car frame) by a biasing element 424.

As noted above, the car apron assembly 400 of the present disclosure is configured with a wound or winding aspect. That is, as the elevator car approaches the pit, the semi-rigid curtain 402 may wind or roll into the housing 418. When the elevator car moves away from the pit, the force of gravity and/or the biasing elements 424 may urge the semi-rigid curtain 402 back into a deployed state.

FIG. 4B illustrates the semi-rigid curtain 402 in the fully deployed state, which is the state during normal operation of an elevator car. As shown, the semi-rigid curtain 402 is deployed to the deployed length LD. FIG. 4C illustrates the semi-rigid curtain 402 in a stowed state, which is caused by the elevator car moving close to and toward a pit floor 427. In the stowed state, the semi-rigid curtain 402 is rolled-up or wound within the housing 418.

In this illustrative embodiment, the apron frame 406 includes an apron buffer 426 located on a bottom of the apron frame 406. The apron buffer 426 extends to a position that is lower than the maximum extent of the semi-rigid curtain 402 relative to the apron frame 406. That is, when approaching the pit floor 427, the apron buffer 426 will contact the pit floor 427 before the semi-rigid curtain 402 can contact the pit floor 427. In such configurations, the apron buffer 426 will apply force to the apron frame 406 by contacting the pit floor 427, and thus urging the guides 420 upward relative to the car frame 422. As the guides 420 move upward relative to the car frame 422, the apron frame 406 will move upward as well, thus urging the semi-rigid curtain 402 to roll into the housing 418. The semi-rigid curtain 402 may be wound about a winding mechanism 428 that is installed within the housing 418. The winding mechanism 428 may be rotatably mounted within the housing 418 to allow for the winding of the semi-rigid curtain 402 within the housing 418. In some embodiments, an end of the semi-rigid curtain 402 may be fixedly attached to the winding mechanism 428.

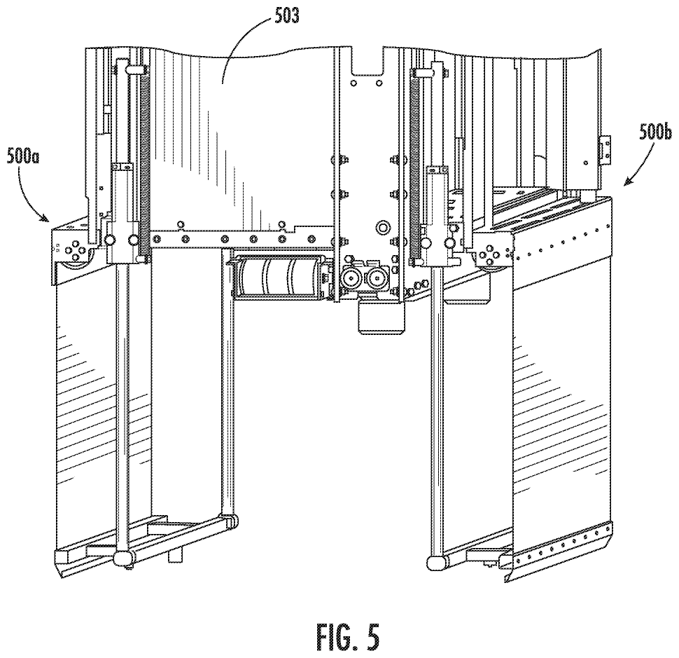

FIG. 5 is an illustrative embodiment wherein an elevator car 503 includes two car apron assemblies 500a, 500b. The car apron assemblies 500a, 500b may be substantially similar to that shown and described above. The configuration shown in FIG. 5 may be employed for elevator cars having two sets of elevator car doors, e.g., on opposing sides of the elevator car 503—to provide ingress/egress from the elevator car 503 from two sides. In operation, the two car apron assemblies 500a, 500b would operate simultaneously, and, in some embodiments, independently from each other.

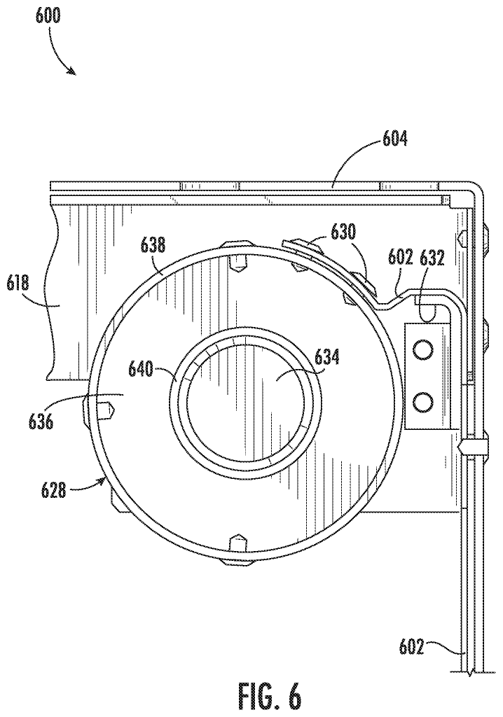

Turning now to FIG. 6, an enlarged schematic illustration of a portion of a car apron assembly 600 in accordance with an embodiment of the present disclosure is shown. The car apron assembly 600 includes a housing 618 installed within an elevator car door sill 604. The housing 618 supports a winding mechanism 628 that is rotatably mounted to the housing 618. In this illustrative embodiment, a semi-rigid curtain 602 is fixedly attached to the winding mechanism 628. As shown, fasteners 630 may attach an end of the semi-rigid curtain 602 to the winding mechanism 628. An apron guide 632 is positioned within the housing 618 and is arranged to guide movement of the semi-rigid curtain 602, in order to enable winding or wrapping (and unwinding/unwrapping) of the semi-rigid curtain 602 about the winding mechanism 628.

In this non-limiting example, the winding mechanism 628 includes multiple elements. For example, as shown, the winding mechanism 628 includes a shaft 634 (or axle) that is rotatably mounted to the housing 618. A drum 636 is arranged about the shaft 634, with the drum providing a diameter of sufficient size to prevent damage to the semi-rigid curtain 602 as the semi-rigid curtain 602 is wound about the winding mechanism 628. Further, as shown, the winding mechanism 628 includes a contact surface 638 (e.g., an applied coating, an external surface of the drum 636, a material layer, etc.). The contact surface 638 may be configured to prevent bonding or sticking of the semi-rigid curtain 602 to the winding mechanism 628 as the semi-rigid curtain 602 is wound about the winding mechanism 628. In some embodiments, self-lubricated bushings 640 may be arranged between the shaft 634 and the drum 636.

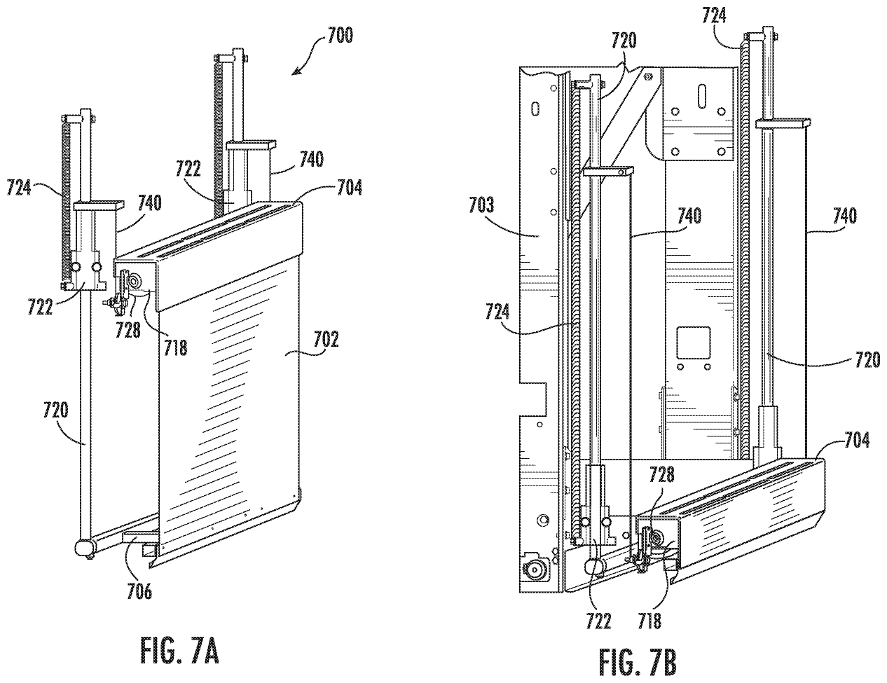

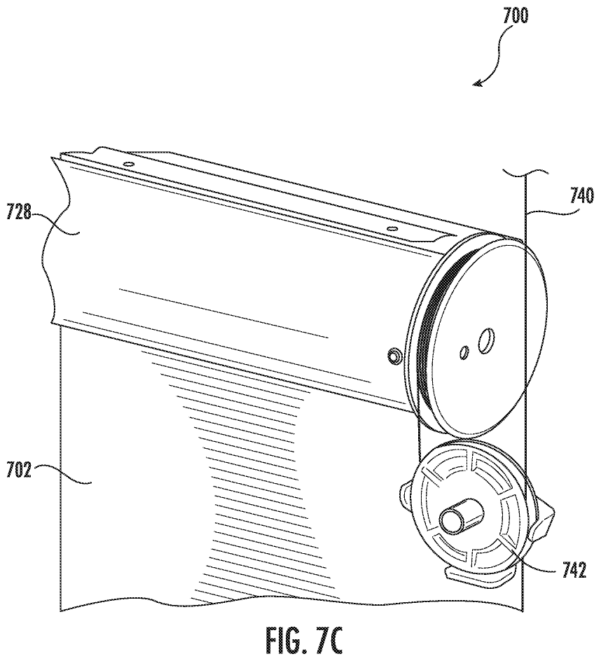

Turning now to FIGS. 7A-7C, schematic illustrations of a car apron assembly 700 in accordance with an embodiment of the present disclosure are shown. The car apron assembly 700 may be installed to an elevator car 703 (shown in FIG. 7C) as shown and described above. The car apron assembly 700 is provided to prevent injury if the landing doors are open and the elevator car 703 is not aligned with a given landing. FIG. 7A illustrates an isometric view of the car apron assembly 700 in a deployed or extended state. FIG. 7B illustrates an isometric view of the car apron assembly 700 in a wound or collapsed state when the elevator car 703 is located proximate a pit floor of an elevator shaft. FIG. 7C is an enlarged illustration of a portion of the car apron assembly 700 illustrating elements thereof.

The car apron assembly 700 includes a semi-rigid curtain 702 that is installed in and suspended from an elevator car door sill 704 of the elevator car 703. As shown, the semi-rigid curtain 702 is housed within a housing 718 that may be part of the elevator car door sill 704. The semi-rigid curtain 702 extends downward from and below the elevator car door sill 704, as shown in FIG. 7A. As shown in FIG. 7A, the semi-rigid curtain 702 extends from the elevator car door sill 704 and is supported by an apron frame 706. The apron frame 706 provides rigidity, support, and weight to the semi-rigid curtain 702. The apron frame 706, in some embodiments, may be a metal rod or beam frame that extends a width of the semi-rigid curtain 702 to provide a weight at the bottom of the semi-rigid curtain 702 and to ensure the semi-rigid curtain 702 remains taut and aligned with an orientation of the elevator car door sill 704 (e.g., may prevent twisting of the semi-rigid curtain 702). Similar to the embodiments described above, the semi-rigid curtain 702 may be wound about a winding mechanism 728.

The apron frame 706 may include one or more guides 720. The guides 720 may be similar in structure and operation as the support arms described above. The guides 720 may be operably connected to a car frame 722 (e.g., part of the elevator car 703) by a biasing element 724. Further, in this embodiment, the winding mechanism 728 may be operably connected to the guides 720. As shown, a driving cable 740 may operably connect the winding mechanism 728 to the guides 720. Thus, as the guides 720 are moved upward, they may cause the winding mechanism 728 to rotate and wind up the semi-rigid curtain 702 on the winding mechanism 728.

As shown in FIG. 7C, the driving cable 740 may connect to the winding mechanism 728 about a pulley 742. That is, the driving cable 740 wraps about the pulley 742 to connect the winding mechanism 728 to the guides 720. The pulley 742 is arranged to position the driving cable 740 relative to the winding mechanism 728. That is, the pulley 742 is arranged to turn the winding direction of the driving cable 90°, without interfering with operation of the winding mechanism 728.

Advantageously, embodiments described herein provide a protective car apron assembly to prevent accidental falls into an elevator shaft when an elevator car is positioned offset from a landing. Further, advantageously, the car apron assemblies of the present disclosure can provide falling hazard protection, enable low pits (due to winding or stowage), may be scalable to different elevator systems, and may provide various other advantages as appreciated by those of skill in the art.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An elevator system comprising:
an elevator car movable along an elevator shaft, the shaft having a pit floor, the elevator car having an elevator car door sill; and
a car apron assembly comprising:
an apron frame movably mounted to the elevator car, the apron frame having a frame base;
a winding mechanism mounted within the elevator car door sill;
a semi-rigid curtain attached to the winding mechanism and extending to the frame base; and
the semi-rigid curtain being configured to transition between a deployed state and a stowed state, wherein when in the deployed state the semi-rigid curtain extends below the elevator car to block an open landing door that is lower than the elevator car when the elevator car is positioned offset and above an adjacent landing, and when in the stowed state the semi-rigid curtain is wound about the winding mechanism.

2. The elevator system of claim 1, wherein the semi-rigid curtain is formed from at least one of rubber, plastic, fabric, metallic chain links, plastic chain links, metal mesh, and plastic mesh.

3. The elevator system of claim 2 wherein the apron frame includes a guide arranged to provide support to the semi-rigid curtain and to guide movement of the semi-rigid curtain between the deployed state and the stowed state.

4. The elevator system of claim 3, further comprising:
an apron stop on an end of the guide opposite the frame base; and
a shaft stop arranged within the elevator shaft at a stop height from the pit floor, the shaft stop positioned within the elevator shaft to interact with the apron stop,
wherein the apron stop is configured to contact the shaft stop and cause the semi-rigid curtain to transition from the deployed state to the stowed state.

5. The elevator system of claim 4, further comprising a driving cable operably connecting the winding mechanism to the guide.

6. The elevator system of claim 5, further comprising a pulley, wherein the driving cable wraps about the pulley.

7. The elevator system of claim 3, further comprising a housing positioned within the elevator car door sill, wherein the winding mechanism is attached to the housing.

8. The elevator system of claim 3 wherein the winding mechanism comprises:
a shaft rotatably mounted to the elevator car door sill; and
a drum driven by rotation of the shaft, wherein the semi-rigid curtain is configured to be wound about the drum.

9. The elevator system of claim 8, further comprising a self-lubricated bushing arranged between the shaft and the drum.

10. The elevator system of claim 8, further comprising a contact surface on an exterior of the drum and configured to prevent the semi-rigid curtain from sticking to the drum.

11. The elevator system of claim 8, wherein the semi-rigid curtain is attached to the drum by one or more fasteners.

12. The elevator system of claim 3, further comprising an apron guide arranged within the elevator car door sill, the apron guide configured to guide movement of the semi-rigid curtain between the deployed state and the stowed state.

13. The elevator system of claim 1 wherein the apron frame includes an apron buffer, the apron buffer configured to contact the pit floor to urge the semi-rigid curtain from the deployed state to the stowed state.

14. The elevator system of claim 1, further comprising a biasing element operably connecting the apron frame to a car frame of the elevator car.

15. The elevator system of claim 1, wherein the elevator car includes a second apron assembly.

16. The elevator system of claim 3, further comprising a driving cable operably connecting the winding mechanism to the guide.

17. The elevator system of claim 1, wherein the apron frame includes a guide arranged to provide support to the semi-rigid curtain and to guide movement of the semi-rigid curtain between the deployed state and the stowed state.

18. The elevator system of claim 1, further comprising a housing positioned within the elevator car door sill, wherein the winding mechanism is attached to the housing.

19. The elevator system of claim 1, wherein the winding mechanism comprises:
a shaft rotatably mounted to the elevator car door sill; and
a drum driven by rotation of the shaft, wherein the semi-rigid curtain is configured to be wound about the drum.

20. The elevator system of claim 1, further comprising an apron guide arranged within the elevator car door sill, the apron guide configured to guide movement of the semi-rigid curtain between the deployed state and the stowed state.
